(19) United States
(12) Patent Application Publication
(10) Pub. No.: US 2017/0082729 A1
(43) Pub. Date: Mar. 23, 2017

(54) POSITIONING DEVICE AND METHOD FOR DETERMINING THE POSITION OF A COMMUNICATION DEVICE

(71) Applicant: Intel IP Corporation, Santa Clara, CA (US)

(72) Inventor: Ofer Bar-Shalom, Kiryat Ono (IL)

(21) Appl. No.: 14/860,740

(22) Filed: Sep. 22, 2015

(51) Int. Cl. G01S 5/10; H04W 4/02

(52) U.S. Cl. CPC G01S 5/10; H04W 4/023

(57) ABSTRACT

A positioning device is described comprising a memory storing, for each reflector of a plurality of reflectors, each generating a reflection of a signal transmitted by a sender, distance information representing the distance of the reflector from the sender and a determiner configured to determine a position of a communication device receiving a superimposition of the signal with the plurality of reflections of the signal generated by the plurality of reflectors based on the received superimposition and the distance information by performing a maximization of the likelihood of the position to be determined based on a difference between an estimated superimposition at the position to be determined and the received superimposition.

### TECHNICAL FIELD

Embodiments described herein generally relate to positioning devices and methods for determining the position of a communication device.

### BACKGROUND

For some applications running on a mobile electronic communication device, such as a smartphone, the location of the smartphone needs to be known, e.g. for a navigation application. Accordingly, an accurate, efficient and low-cost mechanism for positioning (i.e. location determination or estimation) of a mobile electronic device may be desired.

### BRIEF DESCRIPTION OF THE DRAWINGS

In the drawings, like reference characters generally refer to the same parts throughout the different views. The drawings are not necessarily to scale, emphasis instead generally being placed upon illustrating the principles of the invention. In the following description, various aspects are described with reference to the following drawings, in which:

FIG. 1 shows a WLAN (Wireless Local Area Network) communication system.

FIG. 2 shows a positioning device.

FIG. 3 shows a flow diagram illustrating a method for determining the position of a communication device.

FIG. 4 shows a communication arrangement.

FIG. 5 shows, for each an access point and two reflectors, a line-of-position in the form of a circle.

FIG. 6 shows a message flow diagram illustrating a positioning procedure.

### DESCRIPTION OF EMBODIMENTS

The following detailed description refers to the accompanying drawings that show, by way of illustration, specific details and aspects of this disclosure in which the invention may be practiced. Other aspects may be utilized and structural, logical, and electrical changes may be made without departing from the scope of the invention. The various aspects of this disclosure are not necessarily mutually exclusive, as some aspects of this disclosure can be combined with one or more other aspects of this disclosure to form new aspects.

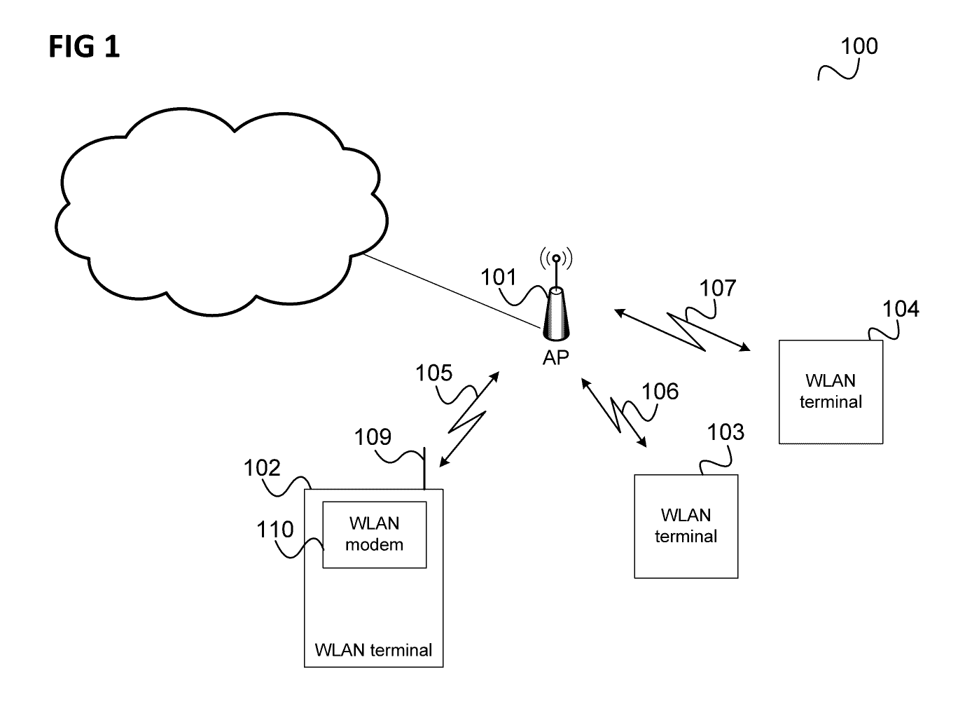

FIG. 1 shows a WLAN (Wireless Local Area Network) communication system 100.

The WLAN communication system 100 comprises a WLAN access point 101 and a plurality of WLAN terminals 102, 103, 104. The WLAN terminals 102, 103, 104 are electronic devices supporting WLAN communication such as smartphones, desktop computers, tablet computers etc. A WLAN communication system 100 according to IEEE 802.11 is also referred to as WiFi communication system. Accordingly, a WLAN terminal 102, 103, 104 is also referred to as WiFi terminal or WiFi station (STA).

Each WLAN terminal 102, 103, 104 may establish a respective radio communication connection 105, 106, 107 to the access point and may access a communication network 108, e.g. the Internet, via the access point 101. As shown in more detail for the first WLAN terminal 102, each WLAN terminal comprises an antenna 109 and a WLAN modem 110 supporting WLAN radio communication.

A lot of WLAN terminals are mobile electronic devices, such as smartphones. Since for some applications, the location of a WLAN terminal needs to be known, e.g. an application which shows the nearest restaurant etc., a mechanism which allows positioning (i.e. location determination or estimation) of a WLAN terminal may be desired.

One WiFi station (STA) geolocation approach is based on ToF (Time of Flight)/ranging measurements with at least three access points. Using the known locations of the access points, the WiFi station can calculate its current location via trilateration. It estimates its location through time delay estimation of the first path delay (line-of-sight, LoS). However, this approach requires a wide install-base/ecosystem of access points supporting the ToF protocol.

In the following, an approach is described which, in case of an application to a WLAN communication system, requires only a single access point with ToF support. The other two access points which would be necessary for the triangulation based approach described above are replaced by reflective devices (e.g. a mirrors, parabolic dishes etc.), placed at nearby locations of access point, wherein these locations (or at least the distance from the access point) are known to the entity which determines the location of the WLAN terminal whose location is to be determined. This approach relaxes the wide install-base assumption and increases the chance that a WLAN terminal can (geo-)locate itself or be located by another entity (e.g. a base station such as a WLAN access point).

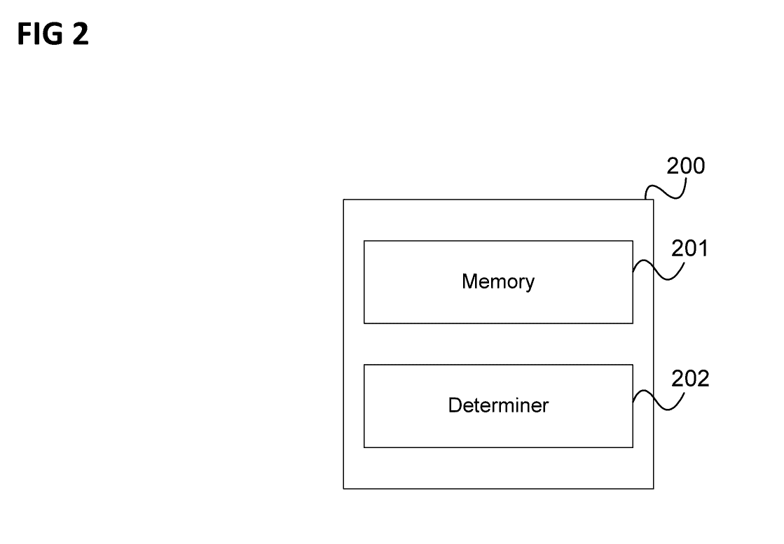

FIG. 2 shows a positioning device 200.

The positioning device 200 comprises a memory 201 storing, for each reflector of a plurality of reflectors, each generating a reflection of a signal transmitted by a sender, distance information representing the distance of the reflector from the sender.

The positioning device 200 further comprises a determiner 202 configured to determine the position of a communication device receiving a superimposition of the signal with the plurality of reflections of the signal generated by the plurality of reflectors based on the received superimposition and the distance information by performing a maximization of the likelihood of the position to be determined based on a difference between an estimated superimposition at the position to be determined and the received superimposition.

In other words, a communication device (e.g. a WLAN terminal) has a receiver which receives a signal from a sender (e.g. a WLAN access point) via a plurality of transmission paths, namely directly from the sender (without intermediate reflector) and via the reflectors such that a superimposition of the signal with its reflected versions arrives at the receiver. Since the various versions of the signal (the one received directly from the sender and the ones received via a reflector) travel different distances, the versions of the signal arrive at the receiver with different delays. Thus, the communication device (or generally a positioning device which may be implemented in the communication device but may for example also be implemented in the sender, e.g. a base station) may perform positioning (also referred to as geolocation), i.e. determine the communication device's position based on an estimation of location-dependent time-delays, i.e. based on the different time delays of the versions of the signal, wherein the time delay of a version of the signal depends on the distance between the sender and the respective reflector and the distance between the receiver (i.e. the communication device) and the respective reflector. This may be done by searching for the location-dependent time delays of the various signal versions that are most probable in view of the received superimposition (and thus the most probably distances of the communication device from the sender and the reflectors), i.e. by determining the maximum-likelihood position estimate of the communication device's location.

The positioning approach of FIG. 2 can thus be seen to utilize a Line-of-Sight (LoS) signal transmission (i.e. directly from the sender), and non-line-of-sight (NLoS) signal reflections that are generated by reflectors (or signal transponders/repeaters), which are placed at locations which are known, e.g. to the sender (e.g. an access point) which may provide information about the reflector positions to the communication device (or another entity performing the positioning).

The communication device (or another device comprising the positioning device, e.g. a base station) can estimate the position of the communication device directly from the signal samples (i.e. in one step). That is as opposed to the triangulation positioning approach described above which includes of a two-step procedure: time-delay estimation in a first step and geolocation based on the estimated time delays in a second step.

The estimated superimposition is for example a superimposition which is expected to result from a reception of the signal and the plurality of reflections.

The determiner may for example be configured to perform the maximization based on a measure of a match of the estimated superimposition with the received superimposition. The measure of the match of the estimated superimposition with the received superimposition may for example be the value of a norm of a difference between the estimated superimposition and the received superimposition. The likelihood of the position to be determined may then be maximized by minimizing the measure (i.e. the value of the norm).

As mentioned above, the positioning device may or may not be part of the communication device. In case it is not part of the communication device, but for example part of the sender (e.g. a base station such as an access point), the communication device may transfer information about the received superimposition (e.g. signal samples) to the positioning device to allow the positioning device to perform the positioning.

The approach described with reference to FIG. 2 for example allows a WiFi station to locate itself using a single access-point in contrast to a geolocation scheme based on fine-time-measurements (FTM) of Time of flight (ToF) with three access points or more. Thus, the approach described with reference to FIG. 2 allows reducing the amount of deployed access points that support ToF and reducing the amount of ToF measurement sessions that the WiFi station needs to conduct (from 3 or more to 1), thereby reducing the time and power consumption and further allows improving geolocation accuracy under low SNR (signal to noise ratio) conditions.

It should be noted that the reflectors may also aid MIMO (multiple input multiple output) communication and improve link quality for all stations and access points in their vicinity.

It should further be noted that the term “reflector” is intended to include passive reflectors such as a mirror or a parabolic dish as well as active reflectors such as a repeater.

The approach described above with reference to FIG. 2 may be applied to a WLAN station (WLAN terminal) or user terminals of other short-range communication technologies such as ZigBee and Bluetooth but may also be used in context of other communication networks, e.g. for a subscriber terminal of a mobile telephone cellular communication network (such that the sender is for example a UMTS or LTE base station).

The positioning device and its components may for example be implemented by one or more circuits (e.g. of the communication terminal whose position is to be determined or the sender or another network component). A “circuit” may be understood as any kind of a logic implementing entity, which may be special purpose circuitry or a processor executing software stored in a memory, firmware, or any combination thereof. Thus a “circuit” may be a hard-wired logic circuit or a programmable logic circuit such as a programmable processor, e.g. a microprocessor. A “circuit” may also be a processor executing software, e.g. any kind of computer program. Any other kind of implementation of the respective functions which will be described in more detail below may also be understood as a “circuit”.

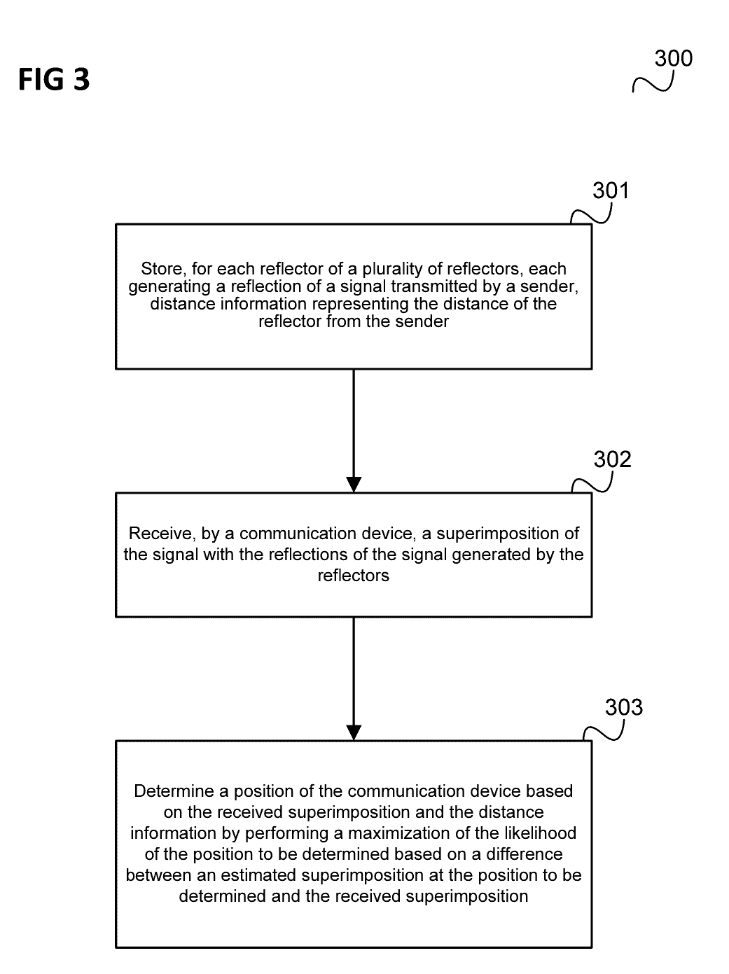

The positioning device may for example carry out a method for determining the position of a communication device as illustrated in FIG. 3.

FIG. 3 shows a flow diagram 300.

In 301 a memory (e.g. of a positioning device) stores, for each reflector of a plurality of reflectors, each generating a reflection of a signal transmitted by a sender, distance information representing the distance of the reflector from the sender.

In 302 a communication device receives a superimposition of the signal with the plurality of reflections of the signal generated by the plurality of reflectors.

In 303 a positioning device (e.g. located in the communication device or located in the sender) determines a position of the communication device based on the received superimposition and the distance information by performing a maximization of the likelihood of the position to be determined based on a difference between an estimated superimposition at the position to be determined with the received superimposition.

The following examples pertain to further embodiments.

Example 1 is a positioning device as illustrated in FIG. 2.

In Example 2, the subject-matter of Example 1 may optionally include the determiner being configured to search for a most probable position of the communication device among a plurality of candidate positions based on the received superimposition and select the most probably position found as the position of the communication device.

In Example 3, the subject-matter of any one of Examples 1-2 may optionally include the determiner being configured to determine the position of the communication device at the time of reception of the superimposition.

In Example 4, the subject-matter of any one of Examples 1-3 may optionally include the plurality of reflectors being stationary reflectors.

In Example 5, the subject-matter of any one of Examples 1-4 may optionally include the sender being a stationary sender.

In Example 6, the subject-matter of any one of Examples 1-5 may optionally include the sender being a base station.

In Example 7, the subject-matter of any one of Examples 1-6 may optionally include the positioning device being implemented in the communication device.

In Example 8, the subject-matter of any one of Examples 1-7 may optionally include the communication device being a communication terminal.

In Example 9, the subject-matter of any one of Examples 1-8 may optionally include the sender being a base station of a cellular communication network and the communication device being a user terminal of the cellular communication network.

In Example 10, the subject-matter of any one of Examples 1-9 may optionally include the determiner being configured to determine the position by searching for a position which minimizes the difference between an expected superimposition for the position and the received superimposition among a plurality of candidate positions.

In Example 11, the subject-matter of Example 10 may optionally include the determiner being configured to iteratively determine the position of the communication device by determining a first estimate of the position of the communication device from among a first plurality of candidate positions followed by determining a second estimate of the position of the communication device among a second plurality of candidate positions wherein the second plurality of candidate positions covers a smaller geographic region than the first plurality of candidate positions and the first estimate of the position being located in the geographic region covered by the second plurality of candidate positions.

In Example 12, the subject-matter of Example 11 may optionally include the second plurality of candidate positions having a finer granularity than the first plurality of candidate positions.

In Example 13, the subject-matter of any one of Examples 10-12 may optionally include the candidate positions being grid points of a two-dimensional or three-dimensional grid covering a geographic region in which the communication device being located.

In Example 14, the subject-matter of any one of Examples 10-13 may optionally include the determiner being configured to determine, for each candidate position, the value of an objective function representing the difference between an expected superimposition for the candidate position and the received superimposition and to select the candidate position for which the value of the objective function represents the minimum difference among the candidate positions as the position of the communication device.

In Example 15, the subject-matter of any one of Examples 1-14 may optionally include the expected superimposition for a position being a superimposition that can be expected to be received by the communication device at the position taking into account the delays of the signal and the reflections of the signal on their transmission paths to the communication device.

In Example 16, the subject-matter of any one of Examples 1-15 may optionally include the determiner being configured to determine the delay of the signal on the transmission paths to the reflectors and configured to determine the position of the communication device based on the determined delays.

In Example 17, the subject-matter of any one of Examples 1-16 may optionally include a further memory storing frequency coefficients of frequency components of the signal wherein the determiner is configured to determine the position of the communication device based on the frequency coefficients.

In Example 18, the subject-matter of any one of Examples 1-17 may optionally include the determiner being configured to determine the position of the communication device based on frequency dependent delays and frequency dependent attenuations of frequency components of the signal.

Example 19 is a communication device comprising the positioning device of any one of Examples 1 to 18 e.g. a base station or a communication terminal.

Example 20 is a method for determining the position of a communication device as illustrated in FIG. 3.

In Example 21, the subject-matter of Example 20 may optionally include searching for a most probable position of the communication device among a plurality of candidate positions based on the received superimposition and selecting the most probably position found as the position of the communication device.

In Example 22, the subject-matter of any one of Examples 20-21 may optionally include determining the position of the communication device at the time of reception of the superimposition.

In Example 23, the subject-matter of any one of Examples 20-22 may optionally include the plurality of reflectors being stationary reflectors.

In Example 24, the subject-matter of any one of Examples 20-23 may optionally include the sender being a stationary sender.

In Example 25, the subject-matter of any one of Examples 20-24 may optionally include the sender being a base station.

In Example 26, the subject-matter of any one of Examples 20-25 may optionally be performed by the communication device.

In Example 27, the subject-matter of any one of Examples 20-26 may optionally include the communication device being a communication terminal.

In Example 28, the subject-matter of any one of Examples 20-27 may optionally include the sender being a base station of a cellular communication network and the communication device being a user terminal of the cellular communication network.

In Example 29, the subject-matter of any one of Examples 20-28 may optionally include determining the position by searching for a position which minimizes the difference between an expected superimposition for the position and the received superimposition among a plurality of candidate positions.

In Example 30, the subject-matter of Example 29 may optionally include iteratively determining the position of the communication device by determining a first estimate of the position of the communication device from among a first plurality of candidate positions followed by determining a second estimate of the position of the communication device among a second plurality of candidate positions wherein the second plurality of candidate positions covers a smaller geographic region than the first plurality of candidate positions and the first estimate of the position being located in the geographic region covered by the second plurality of candidate positions.

In Example 31, the subject-matter of Example 30 may optionally include the second plurality of candidate positions having a finer granularity than the first plurality of candidate positions.

In Example 32, the subject-matter of any one of Examples 29-31 may optionally include the candidate positions being grid points of a two-dimensional or three-dimensional grid covering a geographic region in which the communication device being located.

In Example 33, the subject-matter of any one of Examples 29-32 may optionally include determining, for each candidate position, the value of an objective function representing the difference between an expected superimposition for the candidate position and the received superimposition and selecting the candidate position for which the value of the objective function represents the minimum difference among the candidate positions as the position of the communication device.

In Example 34, the subject-matter of any one of Examples 20-33 may optionally include the expected superimposition for a position being a superimposition that can be expected to be received by the communication device at the position taking into account the delays of the signal and the reflections of the signal on their transmission paths to the communication device.

In Example 35, the subject-matter of any one of Examples 20-34 may optionally include determining the delay of the signal on the transmission paths to the reflectors and determining the position of the communication device based on the determined delays.

In Example 36, the subject-matter of any one of Examples 20-35 may optionally include storing frequency coefficients of frequency components of the signal and determining the position of the communication device based on the frequency coefficients.

In Example 37, the subject-matter of any one of Examples 20-36 may optionally include determining the position of the communication device based on frequency dependent delays and frequency dependent attenuations of frequency components of the signal.

Example 38 is a computer readable medium having recorded instructions thereon which, when executed by a processor, make the processor perform a method for determining the position of a communication device according to any one of Examples 20 to 37.

According to a further example, a radio arrangement comprising the positioning device, the sender, the receiver and the reflectors is provided, wherein the positioning device is for example arranged in a communciation device including the sender or a communication device including the receiver.

It should be noted that one or more of the features of any of the examples above may be combined with any one of the other examples.

In the following, examples are described in more detail.

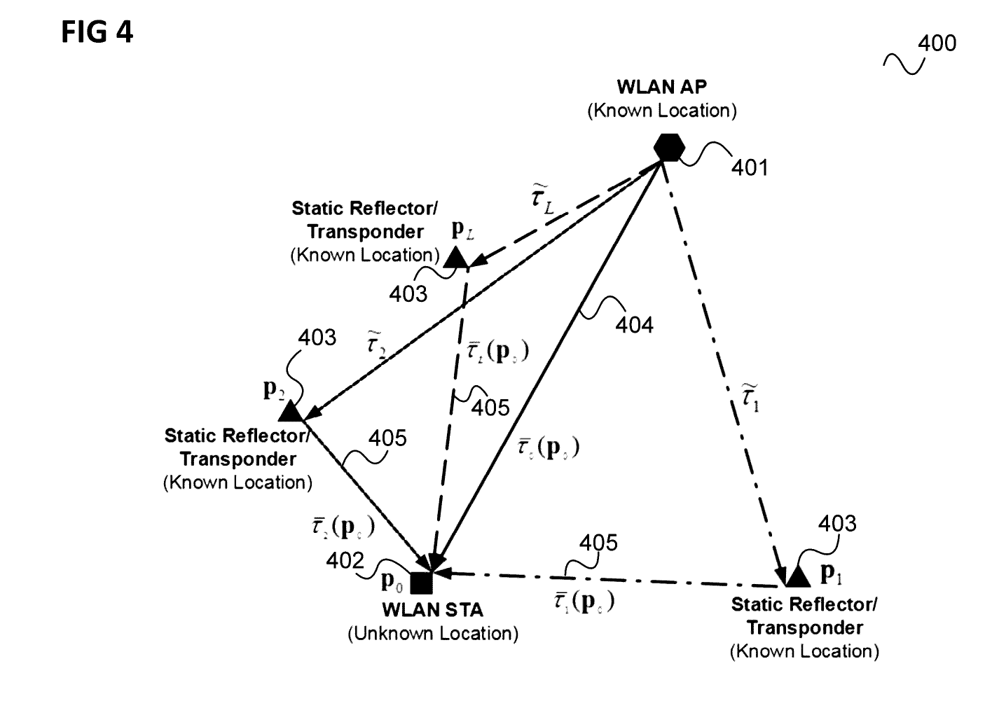

FIG. 4 shows a communication arrangement 400.

The communication arrangement 400 comprises a WLAN access point 401, e.g. corresponding to the access point 101 of the WLAN communication system 100 and a WLAN station 402, e.g. corresponding to the WLAN terminal 102 of the WLAN communication system 100.

The communication arrangement 400 further comprises L reflectors 403 (in the example shown in FIG. 4 L is equal to 3).

The access point 401 sends a (positioning) signal, such as a ToF message, to the WLAN station 402. This signal reaches the WLAN station 402 via a direct path 404 as well as, for each reflector 403, an indirect path 405 that leads from the access point 401 to the WLAN station 402 over the respective reflector.

Thus, the WLAN station 402 receives a multipath signal containing (at least) #L+1 versions of the positioning signal, i.e. a superimposition of the versions of the positioning signal. The version arriving over the direct path 404 from the access point 401 (in other words the LoS version) can be expected to have the lowest time delay and the versions arriving over the indirect paths 405 (in other words the NLoS replicas of the signal) reflected by the reflectors 403 towards the station 401 can be expected to have longer time delays that depend on the lengths of the indirect paths 405.

For the positioning, it is assumed that the WLAN station 402 knows the signal waveform of the positioning signal. For example, information about the positioning signal was stored in a memory of the WLAN station 402. Also, the access point 401 may inform the WLAN station 402 about the waveform of the positioning signal in advance. The WLAN station 402 may also determine the waveform of the positioning signal (as sent by the WLAN station 402) by detecting and decoding the received positioning signal (in other words by reconstructing the positioning signal from the received superimposition).

The positioning signal may for example be an OFDM (Orthogonal Frequency Division Multiplexing) symbol, e.g. using 64 or 128 subcarriers, which is known to the WLAN station 402. The positioning signal may accordingly have a duration of a couple of microseconds.

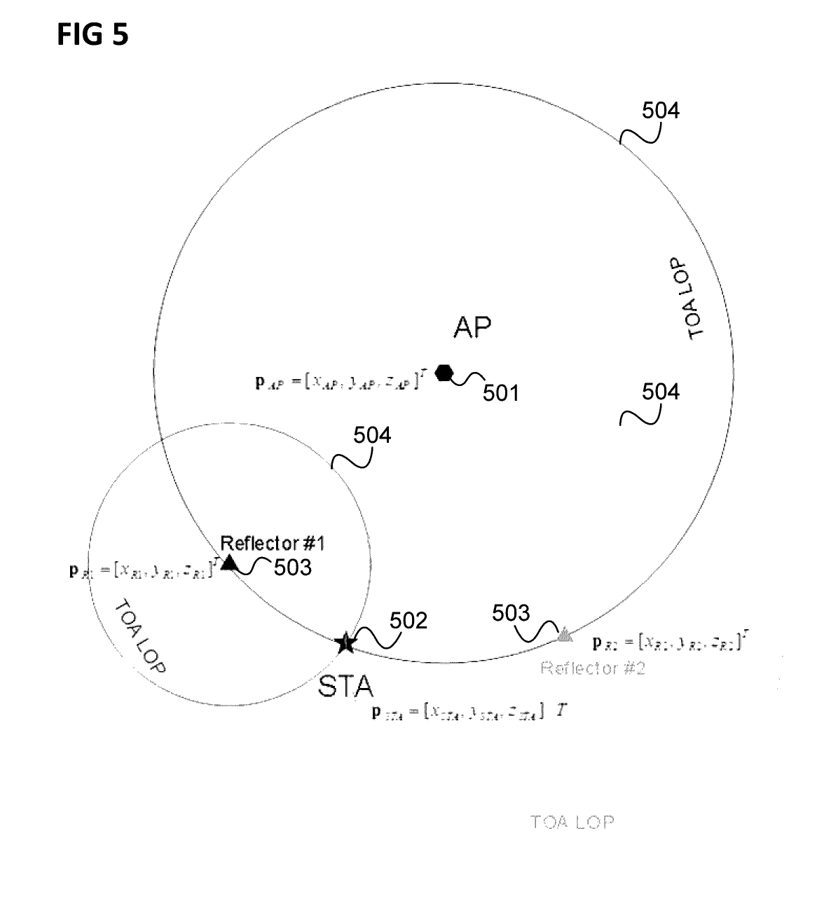

Since the waveform of the positioning signal is known to the WLAN station 402, the WLAN station 402 can determine the delay of the various version of the positioning signal, which gives, for each of the access point 401 and the reflectors 403, a line-of-position (LOP) which is a sphere in 3-D space (or as a circle in 2-D coordinates) around the access point 401 or reflector 403, respectively. The WLAN station 402 can then estimate its position by finding the intersection of the LOPs as illustrated in FIG. 5.

FIG. 5 shows, for each an access point 501 and two reflectors 503, a line-of-position 504 in the form of a circle. At the intersection of the LOPs 504, a WLAN station 502 is located.

Similarly to a ToF estimation procedure based on triangulation, the WLAN station may initiate the positioning procedure.

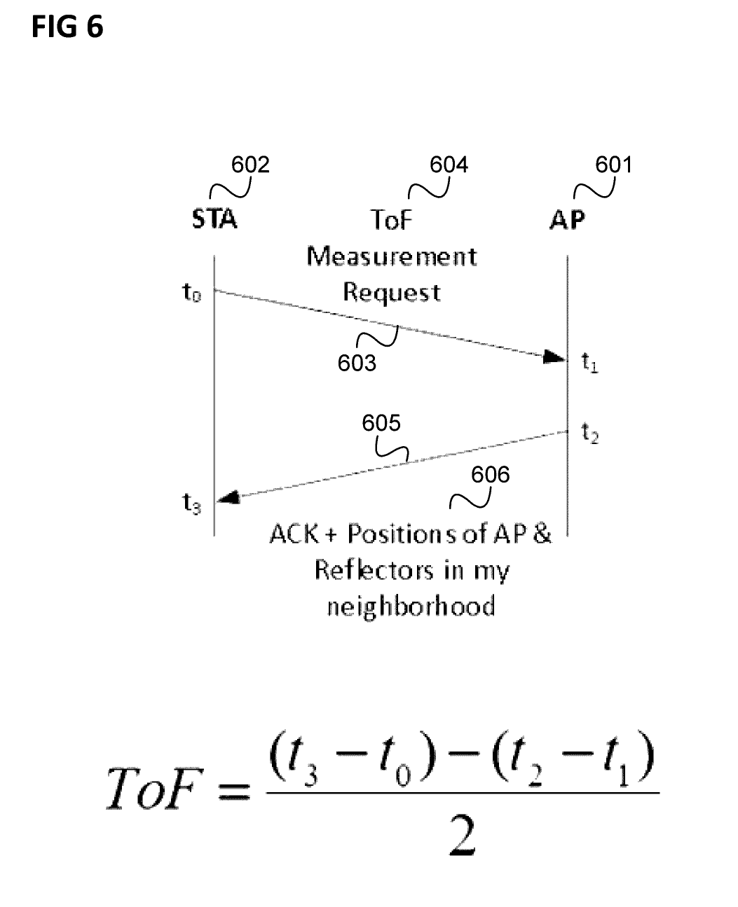

FIG. 6 shows a message flow diagram 600 illustrating a positioning procedure.

The message flow takes place between an access point 601, e.g. corresponding to access point 501 and a WLAN station 602, e.g. corresponding to WLAN station 502.

The WLAN station 602 initiates the positioning process in 603 by sending a ToF measurement request message 604 to the access point 601 at time t₀ which the access point 601 receives at time t₁.

In 605, the access point 601 sends in response a positioning signal 606 which may include a time-stamp as well as information about reflectors deployed in the vicinity of the access point 601 (i.e. of reflectors from which the WLAN station 602 is likely to receive replicas of the positioning signal). The access point may also transmit the information about the reflectors in a separate message. The positioning signal 606 may also act as acknowledgment for the positioning process.

The positioning signal 606 transmitted at time t₂ propagates from the access point 601 to the WLAN station 602 and the reflectors. When the WLAN station receives the positioning signal 606 at a time t₃ it decodes it and extracts the locations of the access point 601 and the reflectors.

Once this information is available at the WLAN station 602, the WLAN station 602 can run a location-search algorithm, e.g. as described in the following.

In the location-search algorithm described in the following, the WLAN station 602 estimates its position via a grid search, where each point on the grid corresponds to a possible location, e.g. on a map of the region where the WLAN station 602 knows to be located (e.g. from the fact that it is in the reception range of the access point 601). The WLAN station 602 evaluates a cost function (see equation (6) below) for every point on the grid. The granularity of the grid depends on the processing-time/budget. For example, the WLAN station 602 may vary the granularity (e.g. in response to a user input or an application request), for example it may choose between a distance of 1 m between two neighboring grid points (in x direction, y direction and possibly z direction in case of a three-dimensional search) and a distance of 5 m between two grid points (in x direction, y direction and possibly z direction in case of a three-dimensional search).

Once the WLAN station 602 has determined the objective function value for each grid point, it can determine the location estimate by searching for the grid point with the maximal objective function value. This grid point corresponds to the estimated WLAN station location.

The WLAN station 602 may repeat the location process iteratively with a finer grid if it needs a higher accuracy (wherein it may reduce the region covered by the grid based on the preceding estimate of its location).

The location algorithm is described for an arrangement as illustrated in FIG. 4 with n reflectors and thus n+1 signal paths. The following denotations are used.

The kth frequency coefficient (k=0, . . . , k−1) of the positioning signal sent by the access point 401 is denoted as s̅ₖ. This is assumed to known to the WLAN station 402.

The time delay of the lth signal path (l=0, . . . , n) including the LoS delay from the access point 401 or reflector 403 to the WLAN station 402 τ̅₁(p), and the delay between access point 401 and reflector 403 \tilde{τ}₁:

τ₁(p)=τ̅₁(p)+\tilde{τ}₁,\tilde{τ}₀=0,p=[x y z]^{T}

wherein p is the position of the WLAN station 402 and \tilde{τ}₀ is the delay between access point 401 and reflector 403 for the direct path (where there is no reflector and thus the delay is zero).

Using the information about the AP and the reflectors position the WLAN station 402 can calculate the values \tilde{τ}₁.

Assuming that the complex gain/attenuation of the lth path is denoted by α₁ and n̅ₖ is the additive noise, the kth frequency coefficient of the received positioning signal (i.e. the superimposition of the various versions of the positioning signal received by the WLAN station 402) is given by

$${\overline{r}}_{k} = {\overline{s}}_{k} \cdot {\sum }_{1 = 0}^{L} {e}^{- {jω}_{k} {τ}_{1}} {α}_{1} + {\overline{n}}_{k} \qquad ( 1 )$$

wherein ωₖ is the angular frequency of the kth frequency coefficient.

With the vectors

$${V}_{k} ≡ [ \begin{matrix}{e}^{- {jω}_{k} {τ}_{0}} \\ {e}^{- {jω}_{k} {τ}_{1}} \\ ⋮ \\ {e}^{- {jω}_{k} {τ}_{L}}\end{matrix} ] , α ≡ [ \begin{matrix}{α}_{0} \\ {α}_{1} \\ ⋮ \\ {α}_{L}\end{matrix} ]$$

equation (1) may be written as

r̅ₖ=\tilde{s}ₖvₖ^{T}α+n̅ₖ. (2)

To concatenate the information for all frequencies, the following matrices and vectors are defined:

$$V ( p ) = [ \begin{matrix}{v}_{0}^{T} \\ {v}_{1}^{T} \\ ⋮ \\ {v}_{K - 1}^{T}\end{matrix} ] , S = [ \begin{matrix}{\overline{s}}_{0} & 0 & … & 0 \\ 0 & {\overline{s}}_{1} & & ⋮ \\ ⋮ & & ⋱ & 0 \\ 0 & … & 0 & {\overline{s}}_{K - 1}\end{matrix} ] , \overline{r} = [ \begin{matrix}{\overline{r}}_{0} \\ {\overline{r}}_{1} \\ ⋮ \\ {\overline{r}}_{K - 1}\end{matrix} ] , \\ \overline{n} = [ \begin{matrix}{\overline{n}}_{0} \\ {\overline{n}}_{1} \\ ⋮ \\ {\overline{n}}_{K - 1}\end{matrix} ]$$

Thus, equation (2) can be written as

r̅=S·V·α+n̅ (3)

wherein the station position p and the complex attenuation vector α are not known. These unknowns may e determined by searching for values \hat{p}_{STA}, \hat{α} of p and α that minimize the cost function ∥r̅−S·V·α∥², i.e.

$${\hat{p}}_{STA} , \hat{α} = {argmin}_{p , α} \{ {‖ \overline{r} - S \cdot V \cdot α ‖}^{2} \} \qquad ( 4 )$$

With D(p)=S·V(p), the vector α that minimizes (4) is given by the least squares estimate (LSE)

\hat{α}=(D^{H}D)⁻¹D^{H}r̅. (5)

Inserting (5) into (4) gives that the WLAN station 402 may estimate its position by maximizing the cost function r̅^{H}D(D^{H}D)⁻¹D^{H}r̅ over a grid containing all possible locations of the WLAN station 402, i.e.

$${\hat{p}}_{STA} = {argmax}_{p} \{ {\overline{r}}^{H} {D ( {D}^{H} D )}^{- 1} {D}^{H} \overline{r} \} \qquad ( 6 )$$

The WLAN station 402 may perform the maximization of equation (6) by a two- or three-dimensional search over x, y and possibly z-coordinates over a two- or three dimensional grid of candidate positions (i.e. possible positions).

While specific aspects have been described, it should be understood by those skilled in the art that various changes in form and detail may be made therein without departing from the spirit and scope of the aspects of this disclosure as defined by the appended claims. The scope is thus indicated by the appended claims and all changes which come within the meaning and range of equivalency of the claims are therefore intended to be embraced.

1. A positioning device comprising:
a memory storing, for each reflector of a plurality of reflectors, each generating a reflection of a signal transmitted by a sender, distance information representing the distance of the reflector from the sender; and
a determiner configured to determine a position of a communication device receiving a superimposition of the signal with the plurality of reflections of the signal generated by the plurality of the reflectors based on the received superimposition and the distance information by performing a maximization of the likelihood of the position to be determined based on a difference between an estimated superimposition at the position to be determined and the received superimposition.

2. The positioning device of claim 1, wherein the determiner is configured to search for a most probable position of the communication device among a plurality of candidate positions based on the received superimposition and select the most probably position found as the position of the communication device.

3. The positioning device of claim 1, wherein the determiner is configured to determine the position of the communication device at the time of reception of the superimposition.

4. The positioning device of claim 1, wherein the plurality of reflectors are stationary reflectors.

5. The positioning device of claim 1, wherein the sender is a stationary sender.

6. The positioning device of claim 1, wherein the sender is a base station.

7. The positioning device of claim 1, wherein the positioning device is implemented in the communication device.

8. The positioning device of claim 1, wherein the communication device is a communication terminal.

9. The positioning device of claim 1, wherein the sender is a base station of a cellular communication network and the communication device is a user terminal of the cellular communication network.

10. The positioning device of claim 1, wherein the determiner is configured to determine the position by searching for a position which minimizes the difference between an expected superimposition for the position and the received superimposition among a plurality of candidate positions.

11. The positioning device of claim 10, wherein the determiner is configured to iteratively determine the position of the communication device by determining a first estimate of the position of the communication device from among a first plurality of candidate positions followed by determining a second estimate of the position of the communication device among a second plurality of candidate positions wherein the second plurality of candidate positions covers a smaller geographic region than the first plurality of candidate positions and the first estimate of the position is located in the geographic region covered by the second plurality of candidate positions.

12. The positioning device of claim 11, wherein the second plurality of candidate positions has a finer granularity than the first plurality of candidate positions.

13. The positioning device of claim 10, wherein the candidate positions are grid points of a two-dimensional or three-dimensional grid covering a geographic region in which the communication device is located.

14. The positioning device of claim 10, wherein the determiner is configured to determine, for each candidate position, the value of an objective function representing the difference between an expected superimposition for the candidate position and the received superimposition and to select the candidate position for which the value of the objective function represents the minimum difference among the candidate positions as the position of the communication device.

15. The positioning device of claim 1, wherein the expected superimposition for a position is a superimposition that can be expected to be received by the communication device at the position taking into account the delays of the signal and the reflections of the signal on their transmission paths to the communication device.

16. The positioning device of claim 1, wherein the determiner is configured to determine the delay of the signal on the transmission paths to the reflectors and configured to determine the position of the communication device based on the determined delays.

17. The positioning device of claim 1, comprising a further memory storing frequency coefficients of frequency components of the signal wherein the determiner is configured to determine the position of the communication device based on the frequency coefficients.

18. The positioning device of claim 1, wherein the determiner is configured to determine the position of the communication device based on frequency dependent delays and frequency dependent attenuations of frequency components of the signal.

19. A method for determining the position of a communication device comprising:
storing, for each reflector of a plurality of reflectors, each generating a reflection of a signal transmitted by a sender, distance information representing the distance of the reflector from the sender;
receiving, by a communication device, a superimposition of the signal with the plurality of reflections of the signal generated by the plurality of reflectors;
determining a position of the communication device based on the received superimposition and the distance information by performing a maximization of the likelihood of the position to be determined based on a difference between an estimated superimposition at the position to be determined and the received superimposition.

20. A computer readable medium having recorded instructions thereon which, when executed by a processor, make the processor perform a method for determining the position of a communication device according to claim 19.
